(19) United States
(12) Patent Application Publication
(10) Pub. No.: US 2004/0154909 A1
(43) Pub. Date: Aug. 12, 2004

(54) Control panel assembly of washing machine

(76) Inventors: Jong Seok Kim, Changwon-si (KR); Yang Hwan No, Changwon-si (KR); Han Ki Cho, Changwon-si (KR); Yeon Su Jung, Changwon-si (KR); Jung Hoon Kang, Changwon-si (KR); Myung Sik Park, Changwon-si (KR); Young Hoon Ha, Masan-si (KR)

Correspondence Address: BIRCH STEWART KOLASCH & BIRCH, PO BOX 747, FALLS CHURCH, VA, 22040-0747, US

(21) Appl. No.: 10/721,330

(22) Filed: Nov. 26, 2003

(30) Foreign Application Priority Data
Nov. 29, 2002 (KR) P2002-0075354

(51) Int. Cl. H01H 9/02; H01H 9/04

(52) U.S. Cl. 200/296

(57) ABSTRACT

Disclosed is a control panel assembly of a washing machine, in which a control panel is strongly coupled with a top plate with ease. The present invention includes a top plate on a cabinet, the top plate having at least one coupling hole, a control panel on the top plate, the control panel having electronic parts installed therein, and at least one coupling member at a bottom of the control panel to be inserted in the coupling hole to prevent the control panel being separated from the top plate by an external force.

This application claims the benefit of Korean Application(s) No. 10-2002-0075351 filed on Nov. 29, 2002, which is/are hereby incorporated by reference.

### BACKGROUND OF THE INVENTION

1 . Field of the Invention

The present invention relates to a washing machine, and more particularly, to a control panel assembly of a washing machine, in which a control panel is strongly coupled with a top plate with ease.

2. Discussion of the Related Art

Generally, a washing machine performs washing, rinsing, and dewatering to eliminate dirt or filth attached to a laundry using interaction between water and detergent. And, such a washing machine belongs to one of a pulsator type, an agitator type, and a drum type.

A control panel is installed in the washing machine to control an operation of the washing machine.

FIG. 1 is a schematic cross-sectional view of a drum type washing machine according to a related art.

Referring to FIG. 1, in a drum type washing machine according to a related art, a cabinet 2 made of a metal-based material forms an exterior. An entrance is formed at a front side of the cabinet 2, and a door 16 is installed at the entrance to prevent a laundry from popping out.

And, a top plate 20 and a base 22 are provided at a top and bottom of the cabinet to form top and bottom sides of the washing machine, respectively. Moreover, a tub 6 supported by a spring 4 is installed in the cabinet 2 to hold water.

A drum 8 in which the laundry and detergent are put is rotatably installed in the tub 6. A rotational shaft 14 coupled with a motor 12 is installed in a rear side of the drum 8 to transfer a driving force to the drum 8. And, lifts 10 are installed on an inside of the drum 8 to pull up the laundry to fall.

Meanwhile, a gasket 18 formed of such an elastic material as rubber is installed between the door 16 and the tub 6. The gasket 18 alleviates a shock generated from a rotation of the drum 8 as well as makes the door 16 airtight to prevent the water from leaking.

And, a damper 34 is installed at one side under the tub 6. The damper 34 attenuates the vibration transferred to the tub 6 through the rotational shaft 14 while the washing machine operates.

Moreover, a water supply hose 28, a water supply valve 30, and a detergent box 32 are installed in an upper part of the cabinet 2 to supply the water and detergent to the tub 6. And, a drain pump 24 and a drain hose 26 are installed at one side under the tub 6 to circulate or discharge the water.

Meanwhile, a control panel 40, on which electronic parts for controlling an operation of the drum type washing machine are provided, is installed on the top plate 20. The control panel 40 is used for displaying an operational status of the drum type washing machine or controlling the operation of the washing machine by a user himself.

FIG. 2 is a perspective view of a control panel disassembled from a washing machine according to a related art, and FIG. 3 is a cross-sectional view of a control panel assembly according to a related art.

Referring to FIG. 2 and FIG. 3, a control panel 40 according to a related art is coupled with a top plate 20 provided on a cabinet 2. For this, a holder 42 is provided at a bottom of the control panel 40, and a hole 41 is formed in the top plate 20 so that the holder 42 is inserted in the hole 41.

The holder 42 consists of a first holder 43 and a second holder 44. The first holder 43 prevents the control panel 40 from being pushed in a front direction, whereas the second holder 44 prevents the control panel 40 from being pushed in a rear direction.

And, the hole 41 consists of a first hole 45 and a second hole 46 so that the first and second holders 43 and inserted in the first and second holes 45 and 46, respectively.

As the holder 42 is inserted in the hole 41, the control panel 40 is coupled with the top plate 20. Specifically, the control panel is tilted in a front direction of the washing machine so that the first holder 43 is inserted in the first hole 45. The control panel 40 is then rotated centering around the first holder 43 to insert the second holder 44 in the second hole 46, thereby being completely coupled with the top plate 20.

Meanwhile, an opening is provided at a rear side of the control panel 40 for repairing or replacing electronic parts 36 installed inside. And, a back panel 48 is installed on the opening to open/close if necessary.

However, the related art control panel assembly has the following problems or disadvantages.

First of all, it is not easy to insert the holder in the hole in assembling the control panel to the top plate. Specifically, the assembly process becomes more difficult if the control panel is large-sized or weighs heavier.

Secondly, the holder may be separated from the hole of the top plate when an external force is applied thereto from the front side of the control panel.

### SUMMARY OF THE INVENTION

Accordingly, the present invention is directed to a control panel assembly of a washing machine that substantially obviates one or more of the problems due to limitations and disadvantages of the related art.

An object of the present invention, which has been devised to solve the foregoing problem, lies in providing a control panel assembly of a washing machine, which facilitates to couple a control panel strongly with a top plate.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a control panel assembly of a washing machine according to the present invention includes a top plate on a cabinet, the top plate having at least one coupling hole, a control panel on the top plate, the control panel having electronic parts installed therein, and at least one coupling member at a bottom of the control panel to be inserted in the coupling hole to prevent the control panel being separated from the top plate by an external force.

In this case, the at least one coupling member is a hook having an arrow-shaped cross-section. And, the hook preferably comprises first and second hooks symmetrical to each other to provide a predetermined space therebetween. Moreover, the hook is formed at each of right and left bottom sides of the control panel.

Meanwhile, a screw coupling hole for screw coupling is formed at each of the top plate and the control panel. And, a screw coupling boss is formed at the bottom of the control panel to correspond to the screw coupling hole.

And, the at least one coupling member at the bottom of the control panel is a hook having an arrow-shaped cross-section. In this case, the hook preferably comprises first and second hooks symmetrical to each other to provide a predetermined space therebetween.

Meanwhile, an align hole for informing a coupling position of the control panel is formed at a top of the top plate and wherein a fixing protrusion extends from the bottom of the control panel to be inserted in the align hole.

And, the at least one coupling member at the bottom of the control panel is a hook having an arrow-shaped cross-section. In this case, the hook preferably comprises first and second hooks symmetrical to each other to provide a predetermined space therebetween.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic cross-sectional view of a drum type washing machine according to a related art;

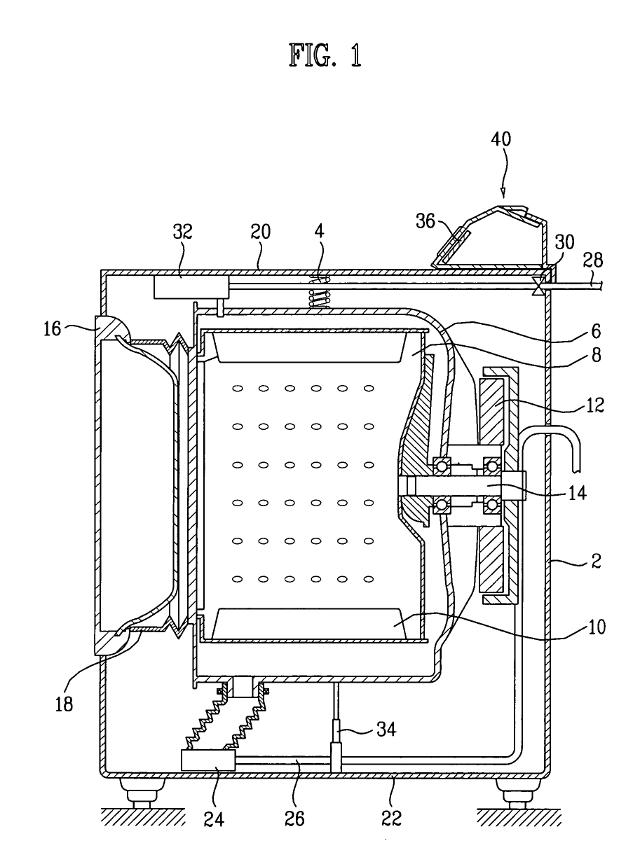

FIG. 2 is a perspective view of a control panel disassembled from a washing machine according to a related art;

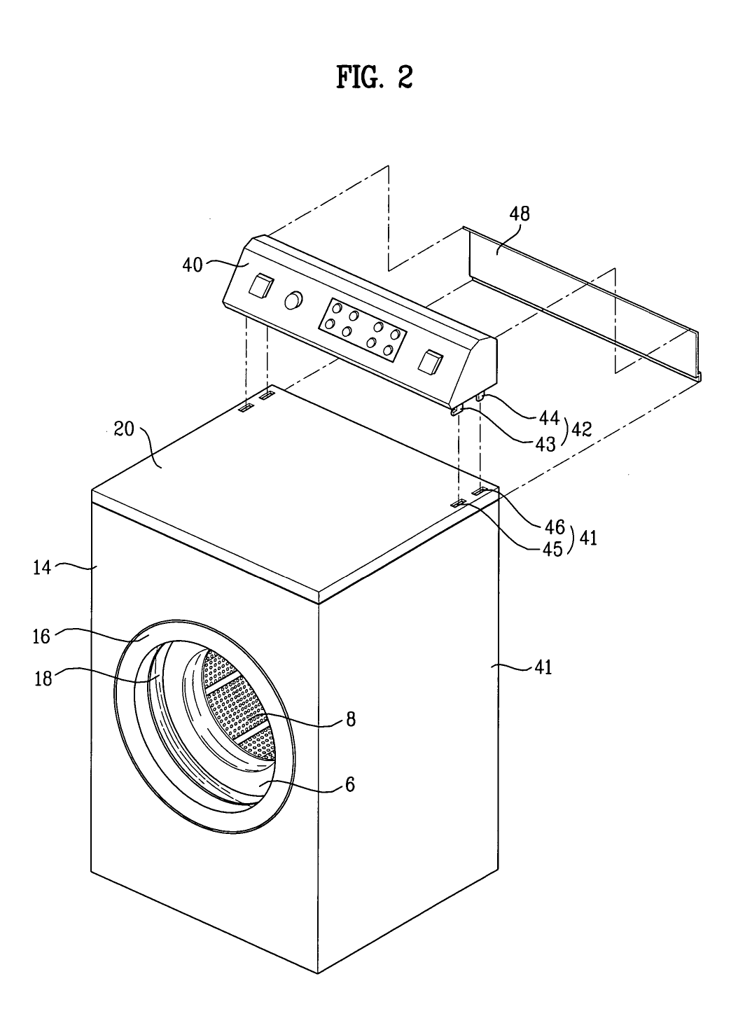

FIG. 3 is a cross-sectional view of a control panel assembly according to a related art;

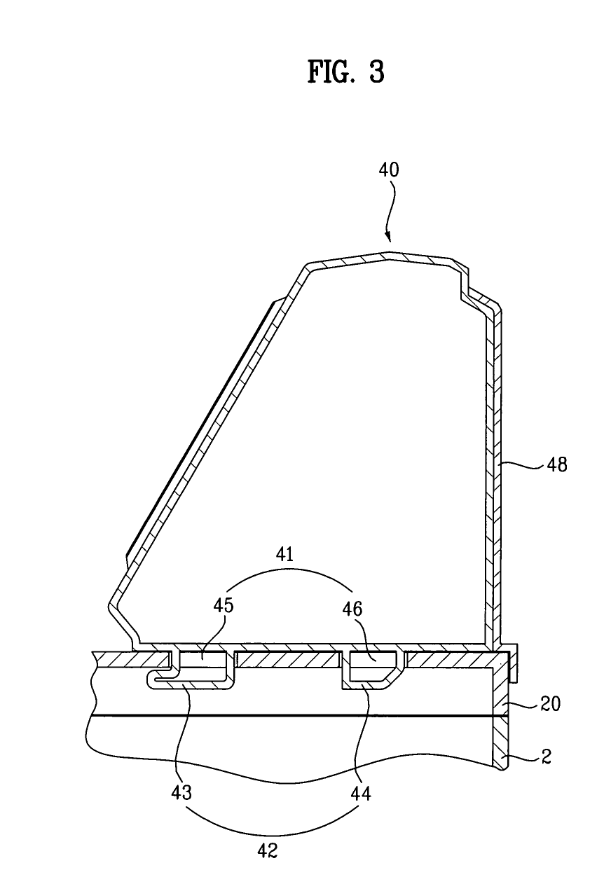

FIG. 4 is a perspective view of a control panel disassembled from a washing machine according to the present invention;

FIG. 5 is a magnified view of ‘A’ in FIG. 4; and

FIG. 6 is a cross-sectional view of a control panel assembly according to the present invention.

### DETAILED DESCRIPTION OF THE PREFERRED EMBODIMENT(S)

Reference will now be made in detail to the preferred embodiment(s) of the present invention, examples of which are illustrated in the accompanying drawings. Throughout the drawings, like elements are indicated using the same or similar reference designations where possible.

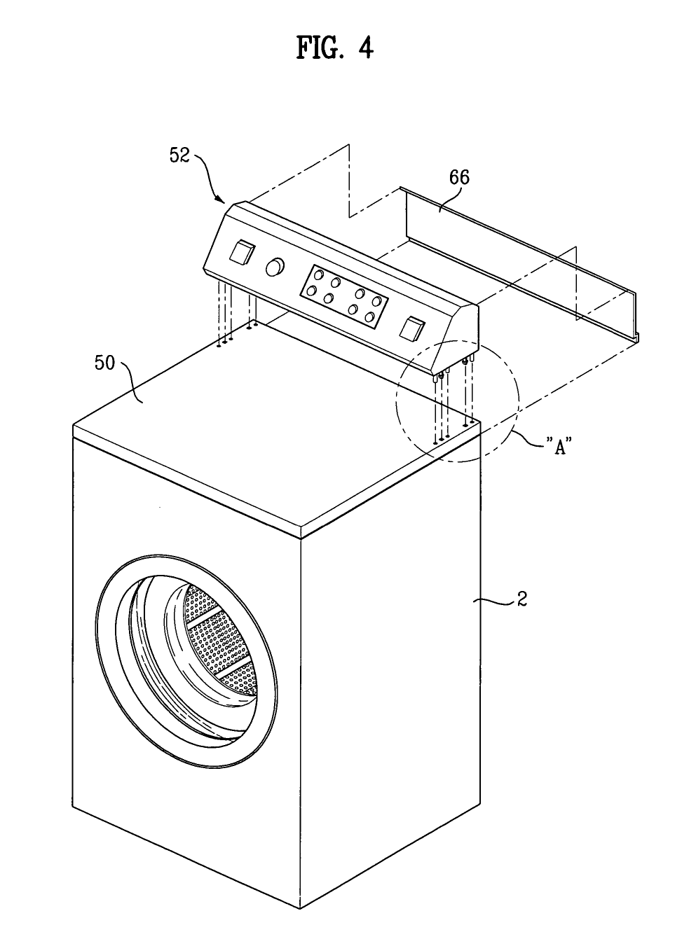

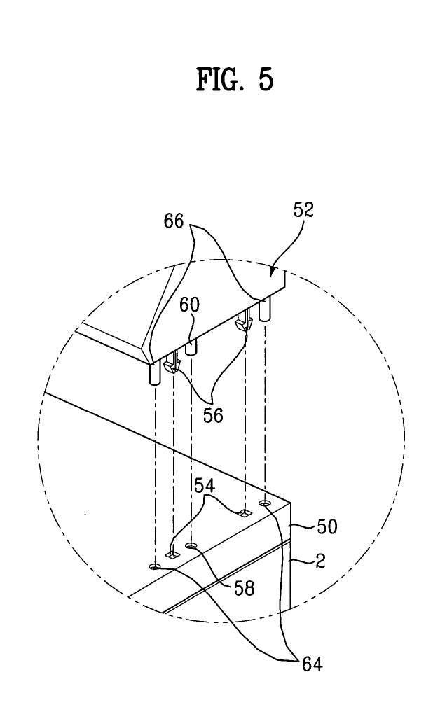

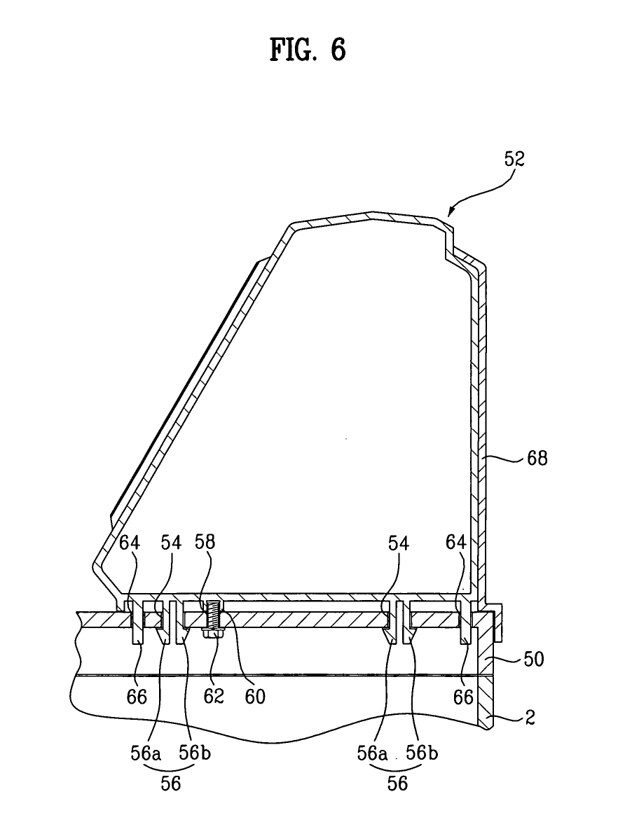

FIG. 4 is a perspective view of a control panel disassembled from a washing machine according to the present invention, FIG. 5 is a magnified view of ‘A’ in FIG. 4, and FIG. 6 is a cross-sectional view of a control panel assembly according to the present invention.

Referring to FIGS. 4 to 6, a control panel assembly according to the present invention includes a top plate 50 provided on a cabinet 2 and a control panel 52 provided on the top plate 50.

At last one coupling hole 54 is formed at the top plate 50, and electronic parts are installed in the control panel 52. The control panel is constituted to display an operational status of the washing machine to a user or to allow the user to control an operation of the washing machine.

And, at least one coupling member 56 is formed at a bottom of the control panel 52 so as to be inserted in the corresponding coupling hole 54 to prevent the control panel 52 from being separated from the top plate 50 by an external force.

In this case, the coupling member 56 is a hook 56, of which cross-section is an arrow type, to be easily coupled with the coupling hole 54 and to prevent the separation of the control panel 52.

Specifically, the hook 56 preferably includes first and second hooks 56a and 56b symmetrical to each other to provide a predetermined space therebetween. The first and second hooks 56a and 56b contract into the provided space to be easily coupled with the coupling hole 54 when inserted in the coupling hole 56. After completion of the coupling, the first and second hooks 56a and 56b are elastically restored to be strongly coupled with the bottom of the top plate 50.

A screw coupling hole 58 is formed in the top plate 50 and a screw boss 60 is formed at a bottom of the control panel 52 to correspond to the screw coupling hole 58.

Hence, a screw 62 is screw-driven into the screw coupling hole and boss 58 and 60 from the bottom of the top plate 50 for coupling.

Moreover, an align hole 64 is formed at the top of the top plate 50 to inform a coupling position of the control panel 52, and a fixing protrusion 66 extends from the bottom of the control panel 52 to be inserted in the align hole 64.

Thus, the hook 56, screw coupling boss 60, and fixing protrusion 66 are formed at each bottom side of the control panel 52, whereas the coupling hole 54, screw coupling hole 58, and align hole 64 are correspondingly formed at each top side of the top plate 50. Of course, the formation positions of the fixing protrusion 66, hook 56, and the like are lot limited to both of the bottom sides of the control panel 52. And, they can be formed in a central bottom of the control panel 52 for example.

Meanwhile, an opening is provided at a rear side of the control panel 52 for repairing or replacing electronic parts installed inside. And, a back panel 68 is installed on the opening to open/close if necessary.

An assembling process of the control panel and top plate 50 of the washing machine according to the present invention is explained as follows.

First of all, the fixing protrusion 66 of the control panel 52 is disposed at a position corresponding to the align hole 50 of the top plate 50. The control panel 52 is then lowered to insert the fixing protrusion 66 in the align hole 64 so that the control panel 52 is mounted on the top plate 50.

In this case, since the hook 56 is inserted in the coupling hole 54 to be coupled as well, the control panel 52 is fixed to the top plate 50 so as not to be separated from the top plate 50.

Thus, after the control panel 52 has been coupled to the top of the top plate 50, the screw 62 penetrates into the screw coupling hole and boss 58 and 60 from the bottom side of the top plate 50 to be coupled thereto, whereby the control panel 52 is strongly coupled onto the top plate 50.

The control panel assembly of the washing machine according to the present invention has the following advantages or effects.

First of all, the control panel is just put on the top plate so that the fixing protrusion is inserted in the align hole and that the hook is fitted to the coupling hole. Therefore, compared to the related art, the present invention assembles the control panel to the top plate more easily.

Secondly, the control panel is strongly coupled with the top plate by the screw, whereby the control panel is prevented from being pushed or separated from the top plate by the external force.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A control panel assembly of a washing machine, comprising:
a top plate on a cabinet, the top plate having at least one coupling hole;
a control panel on the top plate, the control panel having electronic parts installed therein; and
at least one coupling member at a bottom of the control panel to be inserted in the coupling hole to prevent the control panel being separated from the top plate by an external force.

2. The control panel of the washing machine as claimed in claim 1, wherein the at least one coupling member is a hook having an arrow-shaped cross-section.

3. The control panel of the washing machine as claimed in claim 2, wherein the hook comprises first and second hooks symmetrical to each other to provide a predetermined space therebetween.

4. The control panel of the washing machine as claimed in claim 2, wherein the hook is formed at each of right and left bottom sides of the control panel.

5. The control panel of the washing machine as claimed in claim 1, wherein a screw coupling hole for screw coupling is formed at each of the top plate and the control panel.

6. The control panel of the washing machine as claimed in claim 5, wherein a screw coupling boss is formed at the bottom of the control panel to correspond to the screw coupling hole.

7. The control panel of the washing machine as claimed in claim 5, wherein the at least one coupling member at the bottom of the control panel is a hook having an arrow-shaped cross-section.

8. The control panel of the washing machine as claimed in claim 7, wherein the hook comprises first and second hooks symmetrical to each other to provide a predetermined space therebetween.

9. The control panel of the washing machine as claimed in claim 1, wherein an align hole for informing a coupling position of the control panel is formed at a top of the top plate and wherein a fixing protrusion extends from the bottom of the control panel to be inserted in the align hole.

10. The control panel of the washing machine as claimed in claim 9, wherein the at least one coupling member at the bottom of the control panel is a hook having an arrow-shaped cross-section.

11. The control panel of the washing machine as claimed in claim 10, wherein the hook comprises first and second hooks symmetrical to each other to provide a predetermined space therebetween.
